(19) United States
(12) Patent Application Publication
(10) Pub. No.: US 2024/0181875 A1
(43) Pub. Date: Jun. 6, 2024

(54) APPARATUS AND METHOD FOR DISPLAYING VEHICLE CLUSTER

(71) Applicants: HYUNDAI MOTOR COMPANY, Seoul (KR); KIA CORPORATION, Seoul (KR)

(72) Inventors: Rin Choi, Seoul (KR); Sung Tae Cho, Anyang-si (KR); Young Hoon Kim, Seoul (KR)

(73) Assignees: HYUNDAI MOTOR COMPANY, Seoul (KR); KIA CORPORATION, Seoul (KR)

(21) Appl. No.: 18/519,984

(22) Filed: Nov. 27, 2023

(30) Foreign Application Priority Data
Dec. 6, 2022 (KR) 10-2022-0168817

(51) Int. Cl. B60K 31/18; B60K 35/00; B60W 40/105; B60W 50/14; G06V 20/58

(52) U.S. Cl. CPC B60K 31/185; B60K 35/00; B60W 40/105; B60W 50/14; G06V 20/582; B60K 2370/168; B60W 2050/146; B60W 2420/42; B60W 2555/60; B60W 2556/10

(57) ABSTRACT

A displaying apparatus, includes a speed limit recognition unit configured to obtain a speed limit of a road on which the vehicle travels, and a speedometer display unit configured to display a visual bar varying according to a current speed of the vehicle on a background speed scale image and displaying a visual indicator for the speed limit at a corresponding position of the background speed scale image.

### CROSS-REFERENCE TO RELATED APPLICATION

The present application claims priority to Korean Patent Application No. 10-2022-0168817, filed on Dec. 6, 2022, the entire contents of which is incorporated herein for all purposes by this reference.

### BACKGROUND OF THE PRESENT DISCLOSURE

### Field of the Present Disclosure

The present disclosure relates to a displaying apparatus and a displaying method for a vehicle.

### Description of Related Art

An instrument cluster (hereinafter referred to simply as ‘a cluster’) provided in a vehicle may generally include a tachometer, a speedometer, a fuel gauge, and the like, and display various information associated with the major performance of the vehicle in motion to allow the driver to recognize them easily and visually.

Furthermore, a recently provided navigation device may compare a current speed of the vehicle and a speed limit prescribed for a road on which the vehicle is currently traveling, and when the vehicle exceeds the speed limit, may output voice guiding the driver to decelerate or change the color of a screen or blink to guide the driver to decelerate.

However, unlike the cluster disposed right above the steering wheel, the navigation device is disposed at a location offset aside from the steering wheel, and thus there may cause an inconvenience that the driver needs to move his or her gaze to the side from the forward to check whether the current speed of the vehicle exceeds the speed limit.

Unless the driver move the gaze to the side, he or she may only recognize that the current speed of the vehicle exceeds the speed limit through a voice output from the navigation device.

Furthermore, the speed limit may depend on information stored in the navigation device. Accordingly, when the information stored in the navigation device is not updated, it may not be possible to properly determine over-speeding based on a newly applied speed limit regulation.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a displaying apparatus or method for a vehicle that displays in real time information on a speed limit obtained from a sign recognized while driving to facilitate intuitive comparison with a current speed of the vehicle displayed on a speedometer of the cluster.

A displaying apparatus, according to an exemplary embodiment of the present disclosure, includes a speed limit recognition unit configured to obtain a speed limit of a road on which the vehicle travels, and a speedometer display unit configured to display a visual bar varying according to a current speed of the vehicle on a background speed scale image and display a visual indicator for the speed limit at a corresponding position of the background speed scale image.

In at least an exemplary embodiment of the present disclosure, the speed limit recognition unit is further configured to recognize an image of a road sign based on an image of a pre-registered speed limit sign and obtain the speed limit based on numbers in the image of the road sign.

In at least an exemplary embodiment of the present disclosure, the apparatus further includes a speed limit comparison unit configured to compare the speed limit with a previous speed limit displayed on the speedometer display unit, and determine to change the previous speed limit.

In at least an exemplary embodiment of the present disclosure, the speedometer display unit is configured to adjust a length of the visual bar according to the current speed of the vehicle so that the visual bar approaches the visual indicator as the current speed approaches the speed limit.

In at least an exemplary embodiment of the present disclosure, the visual indicator includes a dot.

In at least an exemplary embodiment of the present disclosure, the visual bar includes a round bar.

In at least an exemplary embodiment of the present disclosure, the apparatus further includes a speed limit comparison unit configured to compare the speed limit obtained by the speed limit recognition unit with a previous speed limit previously displayed on the speedometer display unit to determine which to display.

In at least an exemplary embodiment of the present disclosure, the background speed scale image includes a circular scale, and the speedometer display unit is further configured to display the speed limit inside the circular scale.

In at least an exemplary embodiment of the present disclosure, the apparatus further includes a camera configured to obtain the image of the road sign.

A displaying method, according to an exemplary embodiment of the present disclosure, a speed limit recognition step of obtaining, by a controller provided in the vehicle, a speed limit of a road on which the vehicle travels, and a speedometer display step of displaying, by the controller, a visual bar varying according to a current speed of the vehicle on a background speed scale image and displaying a visual indicator for the speed limit at a corresponding position of the background speed scale image.

In at least an exemplary embodiment of the method, the speed limit recognition step includes recognizing an image of a road sign based on an image of a pre-registered speed limit sign and obtaining the speed limit based on numbers in the image of the road sign.

In at least an exemplary embodiment of the method, the method further includes comparing the speed limit with a previous speed limit displayed on the speedometer display unit, and determining to change the previous speed limit.

In at least an exemplary embodiment of the method, the speedometer display unit is configured to adjust a length of the visual bar according to the current speed of the vehicle so that the visual bar approaches the visual indicator as the current speed approaches the speed limit.

In at least an exemplary embodiment of the method, the visual indicator includes a dot.

In at least an exemplary embodiment of the method, the visual bar includes a round bar.

In at least an exemplary embodiment of the method, the method further includes a speed limit comparison step of comparing the speed limit obtained by the speed limit recognition unit with a previous speed limit previously displayed on the speedometer display unit to determine which to display.

In at least an exemplary embodiment of the method, the background speed scale image includes a circular scale, and the speedometer display unit is further configured to display the speed limit inside the circular scale.

In at least an exemplary embodiment of the method, the method further includes a step of obtaining the image of the road sign by use of a camera.

A non-transitory computer-readable storage medium, according to an exemplary embodiment of the present disclosure, stores computer-readable instructions to cause one or more processors to perform at least one displaying method described above.

According to various embodiments of the present disclosure described herein, displaying in real time a speed limit obtained from a sign recognized while driving to facilitate easy intuitive comparison with a current speed of a vehicle displayed on a speedometer of a cluster provided in the vehicle may allow a driver of the vehicle to easily and visually check whether the speed of the vehicle exceeds or approaches the speed limit while minimizing their gaze movement.

Furthermore, obtaining speed limit information from the sign recognized while driving may enable a determination of whether the vehicle is over-speeding based on a newly applied speed limit regulation without updating information stored in the vehicle.

The effects to be obtained from the present disclosure are not limited to those described above, and other effects not described will be apparent to one having ordinary skill in the art to which the present disclosure pertains from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a cluster displaying apparatus for a vehicle according to an exemplary embodiment of the present disclosure.

FIG. 2 is a diagram illustrating an example of a cluster for a vehicle on which a speed limit is not displayed.

FIG. 3 is a diagram illustrating an example of a cluster for a vehicle on which a speed limit is displayed according to an exemplary embodiment of the present disclosure.

FIG. 4 is a diagram illustrating an example of a cluster for a vehicle displaying a current speed of the vehicle exceeding a speed limit according to an exemplary embodiment of the present disclosure.

FIG. 5 is a diagram illustrating a cluster displaying method for a vehicle according to another exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the present disclosure will be described in detail with reference to the accompanying drawings, and the same or similar elements will be provided the same reference numerals regardless of reference symbols, and redundant description thereof will be omitted. In the following description, the terms “module,” “unit,” and/or “-er/or” for referring to elements are assigned and used interchangeably in consideration of the convenience of description, and thus the terms per se do not necessarily have different meanings or functions. Furthermore, in describing the exemplary embodiments of the present disclosure, when it is determined that a detailed description of related publicly known technology may obscure the gist of the exemplary embodiments described herein, the detailed description thereof will be omitted. The accompanying drawings are used to illustrate various technical features, and it should be understood that the exemplary embodiments presented herein are not limited by the accompanying drawings. Accordingly, the present disclosure should be construed to extend to any alterations, equivalents, and substitutes, in addition to those that are set out in the accompanying drawings.

Although terms including ordinal numbers, such as “first,” “second,” and the like, may be used herein to describe various elements, the elements are not limited by these terms. These terms are only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

Furthermore, the term “unit” or “control unit”, like included in the name of an integrated central control unit (ICU) or electronic control unit (ECU), or the speed limit recognition unit 200, the speed limit comparison unit 300, or the speedometer display unit 400 described below, is merely a widely used term for naming a controller that controls a specific vehicle function, and does not mean a generic functional unit. For example, each unit may include a communication device that communicates with another controller or a sensor to control a function assigned thereto, a memory that stores an operating system (OS), a logic command, input/output information, and the like, and one or more processors that perform calculation, determination, decision, and the like that are necessary for performing a function assigned thereto.

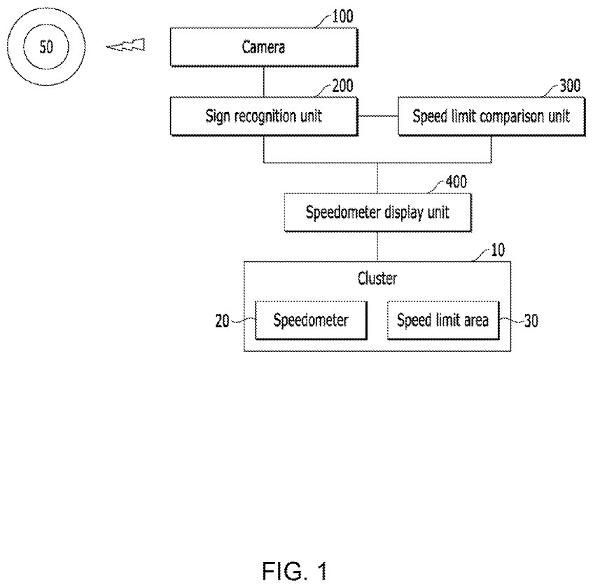

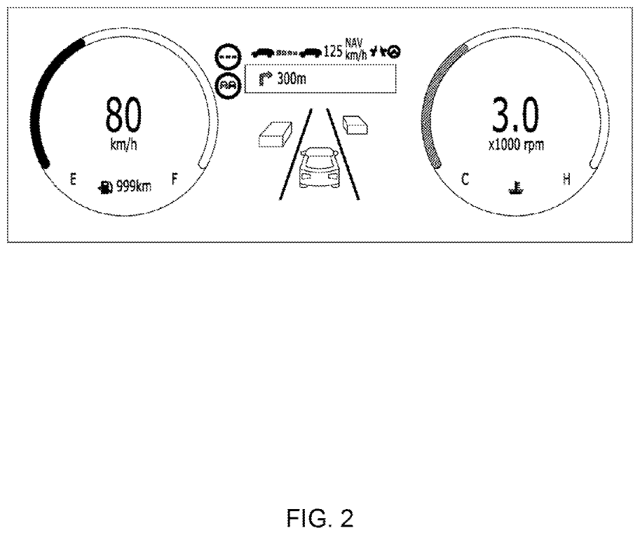

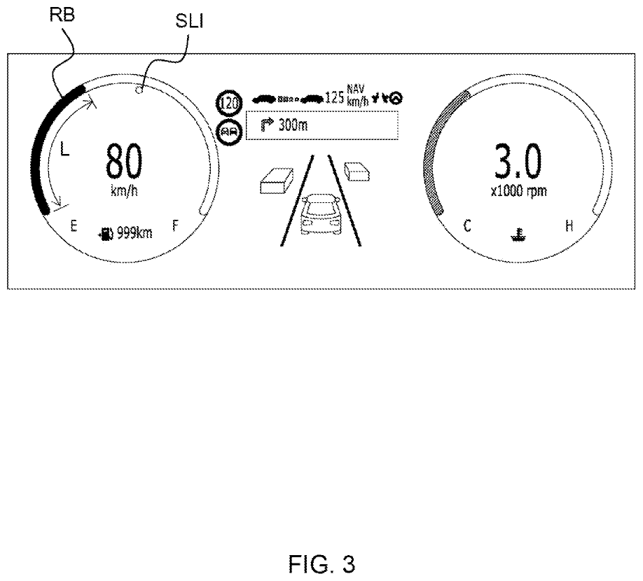

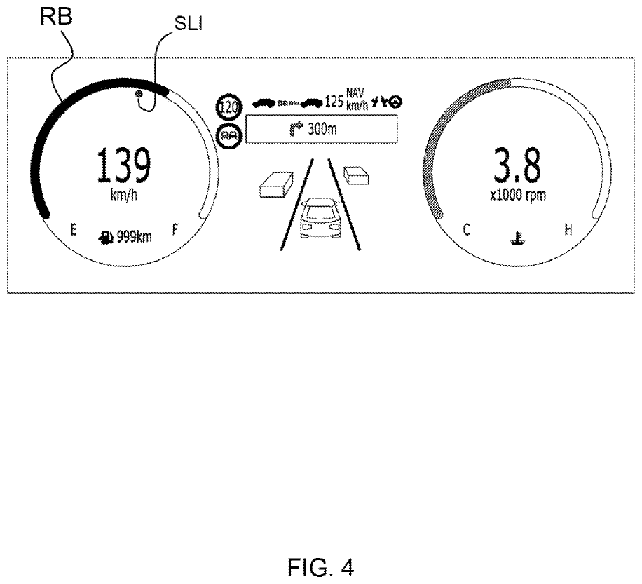

Hereinafter, various embodiments of the present disclosure will be described in detail with reference to FIG. 1, FIG. 2, FIG. 3, and FIG. 4.

FIG. 1 is a block diagram illustrating a displaying apparatus for a vehicle including a camera and a cluster according to an exemplary embodiment of the present disclosure.

Referring to FIG. 1, there is provided in the vehicle a camera 100 which is configured to obtain an image of a sign of a road around the vehicle, and the cluster includes a speed limit recognition unit 200 configured to extract speed limit information from the image of the sign obtained from the camera 100, a speed limit comparison unit 300 configured to compare current speed limit information extracted by the speed limit recognition unit 200 with previous speed limit information that has been displayed on a speedometer of the cluster, and determine speed limit information to be displayed on the speedometer, and a speedometer display unit 400 configured to light and display, on the speedometer of the cluster, the speed limit information determined by the speed limit comparison unit 300 so that the driver can visually recognize the speed limit information.

The speed limit recognition unit 200, the speed limit comparison unit 300, and the speedometer display unit 400 may be programmed and provided in a form of software in an electronic control unit (ECU) of the vehicle, or provided in a form of separate hardware such as a module and the like including a memory and one or more processors as described above.

The camera 100 may obtain the image of a sign by capturing a scene in front of the vehicle while driving, and transmit the obtained image to the speed limit recognition unit 200.

The camera 100 may be implemented as a separate camera provided for obtaining a speed limit, and may also be implemented as an advanced driver assistance system (ADAS) camera provided as a part of an ADAS.

The camera 100 may be used to obtain the image of a (traffic) sign indicating a speed limit. Therefore, it may also be possible to separate and extract only the image of the sign from images obtained by a camera which is already provided in the vehicle, and thus the camera 100 may be implemented as an existing camera, for example, an ADAS camera, which is provided to obtain images around the vehicle.

Furthermore, the speed limit recognition unit 200 may obtain speed limit information from the image of the sign received from the camera 100 by a predetermined image processing. To the present end, the speed limit recognition unit 200 may compare the image of the sign with an image of a pre-registered speed limit sign and determine whether the sign is a speed limit sign.

Generally, a speed limit sign may have numbers that occupy a large proportion inside a circular or polygonal frame, and thus the speed limit recognition unit 200 may be configured to determine whether numbers are written inside a circular or polygonal frame on the image of the sign to determine the sign is a speed limit sign.

Furthermore, in response to a determination that the image of the sign is that of a speed limit sign, the speed limit recognition unit 200 may recognize the numbers written inside the frame to determine a maximum speed limit for the road on which the vehicle is currently traveling.

In the instant case, when a horizontal bar is also recognized under the numbers on the image, the speed limit recognition unit 200 may identify the numbers as a minimum speed limit.

In the present way, the speed limit recognition unit 200 may be configured to determine in real time the maximum or minimum speed limit for the road from the sign recognized directly from the road on which the vehicle is traveling.

A typical navigation device may identify a road on which the vehicle is currently traveling using a current Global Positioning System (GPS) location of the vehicle, and may compare and determine whether the vehicle is currently exceeding a speed limit according to speed limit information of pre-stored map data.

Accordingly, when the map data of the navigation device is not updated, a speed limit for a road may thus inevitably be based on past information, and thus a determination of whether the vehicle over-speeds or not cannot be accurately performed.

The accuracy of a speed limit obtained in real-time through a road sign may be considerably higher than that of a speed limit obtained from map data.

Furthermore, in the case of a variable speed limit (VSL) sign, which is provided mainly in a section vulnerable to weather on a highway to promote safe driving for drivers, a decreased speed may be indicated through a sign in case of bad weather such as rain, snow, fog, or thin ice on a road.

However, even in the case of such a changing speed limit indicated through a VSL sign, depending solely on the map information stored in the navigation device may make it difficult to properly use it as speed limit information for safe driving of a vehicle.

In contrast, the speed limit recognition unit 200 may obtain speed limit information from signs provided on a road on which the vehicle is currently traveling, and may thus determine whether the vehicle is over-speeding based on recent speed limit information at all times.

Furthermore, the speed limit comparison unit 300 may compare the current speed limit information extracted by the speed limit recognition unit 200 with the speed limit information displayed on the speedometer (e.g., a speedometer 20) of the cluster (e.g., a cluster 10), and determine the current speed limit information as the speed limit information to be displayed on the speedometer when they are different and determine to maintain the currently displaying speed limit information when they are the same.

That is, speed limit information may vary depending on a condition or type of road, and thus the speed limit comparison unit 300 may continuously monitor changes while comparing the current speed limit information extracted from the image of the sign with the speed limit information which is currently displayed on the speedometer.

In the instant case, the speed limit comparison unit 300 may be configured to determine the speed limit information to be displayed by comparing only a maximum speed limit, and when minimum speed limit information is also obtained from the image of the sign, may be configured to determine a minimum speed limit to be displayed.

Furthermore, the speedometer display unit 400 may be configured for controlling the cluster 10 to display the speed limit information determined by the speed limit comparison unit 300 on the speedometer 20 of the cluster 10.

To the present end, as shown in FIG. 3 and FIG. 4, the cluster 10 may include a speed limit area 30 in which a shape of dots or numbers is displayed around the speedometer 20 so that the driver visually recognizes the speed limit. In response to obtaining the speed limit information, the display of the cluster 10 is changed from the state of FIG. 2 in which no speed limit information is displayed to the state of FIG. 3 and FIG. 4 in which speed limit information is displayed.

In the instant case, the speed limit area 30 displayed on the speedometer 20 may be set to be displayed together in the vicinity of an area where a current speed of the vehicle is displayed on the speedometer 20, and it may thus be desirable to facilitate comparison between the current speed and the speed limit while minimizing a gaze movement of the driver.

The speedometer of the cluster may be displayed in an electronic form through a light-emitting diode (LED) or liquid crystal display (LCD) panel. In the instant case, a position of such a speed limit area may be programmed and set by a controller that is configured to control information displayed on the light-emitting diode (LED) or LCD panel, and may thus be simply implemented.

Furthermore, as shown in FIG. 3 and FIG. 4, the current speed of the vehicle is indicated in the shape of a round bar RB on a background speed scale image, e.g., a circular-shaped scale. The speedometer display unit 400 is configured to adjust the circumferential length L of the bar according to the current speed. Also, the speed limit area 30 may be set to be displayed in a form of a highlighted dot SLI as a visual indicator at a corresponding position of the background speed scale image, and thus the driver can directly and intuitively recognize how close the current speed approaches to the speed limit by giving a quick glance to the bar RB approaching the dot SLI. Furthermore, the number indicating the speed limit may be displayed at the speedometer as shown by ‘120’ in a circle at a right-upper side of the circular-shaped scale in FIG. 3 and FIG. 4. Also, the current speed may be indicated by numbers, too, in the middle portion of the circular-shaped scale as shown in FIG. 3 and FIG. 4.

The speedometer display unit 400 may light and display the dot SLI or number in the speed limit area 30 based on the speed limit information determined by the speed limit comparison unit 300 and may thereby improve the driver's cognitive convenience, and may also help the driver to rapidly determine whether the speed of the vehicle exceeds or how fast or close it approaches the speed limit by a simple, quick glance at the speedometer and may thereby contribute to safe driving.

Accordingly, the displaying apparatus according to an exemplary embodiment of the present disclosure may directly obtain speed limit information from an image of a sign obtained while driving and display in real time the speed limit information extracted from the obtained image of the sign on a speedometer of a cluster, ensuring safe driving based on accurate speed limit information.

Furthermore, the intuitive display of the speed limit information linked to the speedometer may provide the driver with an experience of rapidly and visually comparing and determining a current speed that corresponds to state information of the vehicle and a speed limit which is legally prescribed.

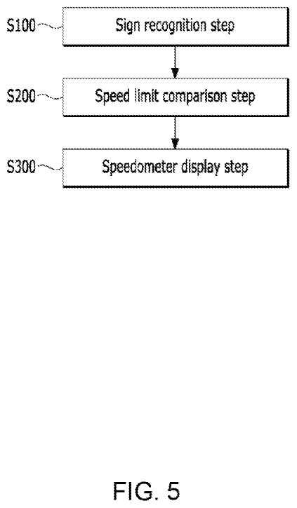

Hereinafter, a displaying method for a vehicle according to another exemplary embodiment of the present disclosure will be described with reference to FIG. 5.

FIG. 5 is a diagram illustrating a displaying method for a vehicle according to another exemplary embodiment of the present disclosure.

Referring to FIG. 5, a displaying method for a vehicle according to another exemplary embodiment of the present disclosure may include a speed limit recognition step S100 in which a controller provided in the vehicle receives an image of a sign from a camera provided in the vehicle and extracts speed limit information from the image of the sign, a speed limit comparison step S200 in which the controller is configured to compare current speed limit information extracted from the image of the sign and recent speed limit information which is being displayed on a speedometer of the cluster of the vehicle, and determine speed limit information to be displayed on the speedometer, and a speedometer display step S300 in which the controller lights and displays the determined speed limit information on the speedometer of the cluster so that the driver visually recognizes the speed limit information.

In the speed limit recognition step S100, the camera may obtain the image of the sign by capturing an image of a front side or both sides of the vehicle during the vehicle is traveling, and transmit the obtained image of the sign to the controller.

In the instant case, the controller may be implemented as an individual control unit that displays, on the cluster, state information of the vehicle including, for example, the speed, engine revolutions, remaining fuel amount, coolant state, and the like, which may be obtained from various sensors provided in the vehicle, or an ECU that is configured to control various electronic devices provided in the vehicle integrally.

The speed limit recognition step S100 may obtain numbers from the image of the sign received from the camera and extract speed limit information therefrom. To the present end, the speed limit recognition step S100 may compare the image of the sign with an image of a pre-registered speed limit sign and determine whether the sign is a speed limit.

A speed limit sign may have numbers that occupy a large proportion inside a circular or polygonal frame, and thus the speed limit recognition step S100 may determine whether numbers are written inside such a frame on the image of the sign to determine whether the sign corresponds a speed limit sign.

Furthermore, in response to a determination that the image is an image of a speed limit sign, the speed limit recognition step S100 may extract the numbers written inside the frame and determine a maximum speed limit for a road on which the vehicle is currently traveling.

In the instant case, if a bar of a certain size is indicated together under the numbers on the image of the sign, the speed limit recognition step S100 may identify the numbers as a minimum speed limit.

In the present way, the speed limit recognition step S100 may identify in real time the maximum speed limit for the road on which the vehicle is currently traveling, from the sign obtained directly from the road on which the vehicle is traveling.

Furthermore, in the case of the sign being a VSL sign which is installed mainly in a section vulnerable to weather on a highway to promote safe driving for drivers, the speed limit recognition step S100 may identify in real time a changed speed limit from an image of the VSL sign.

Furthermore, the speed limit comparison step S200 may compare the current speed limit information extracted in the speed limit recognition step S100 with the speed limit information which is being displayed on the speedometer of the cluster, and may determine the current speed limit information as the speed limit information to be displayed on the speedometer when they are different and maintain the displayed speed limit information when they are the same.

That is, the speed limit comparison step S200 may continuously monitor whether the speed limit for the road on which the vehicle is traveling is changed using the current speed limit information extracted from the image of the sign.

In the instant case, the speed limit comparison step S200 may determine the speed limit information to be displayed by comparing only the maximum speed limit, and when minimum speed limit information is also obtained from the image of the sign, may also determine the minimum speed limit to be displayed.

Furthermore, the speedometer display step S300 may control the cluster to display the speed limit information determined in the speed limit comparison step S200 on the speedometer of the cluster.

To the present end, a speed limit area in which a dot or numbers for a speed limit is displayed may be set around the speedometer in the cluster so that the driver visually recognizes a speed limit therefrom.

In the instant case, for the driver to easily compare the current speed and the speed limit while minimizing the time of distraction of the concentration on the front due to a gaze movement of the driver, the speed limit area displayed on the speedometer may be set to be displayed together in the vicinity of an area where the current speed of the vehicle is displayed on the speedometer.

Furthermore, the current speed of the vehicle is provided in the shape of a round bar on a background speed scale image, e.g., a circular-shaped scale. The bar is adjusted by the controller in length according to the current speed. Also, the speed limit area 30 may be set to be displayed in a form of a highlighted dot as a visual indicator at a corresponding position of the background speed scale image, and thus the driver can directly and intuitively recognize how close the current speed approaches to the speed limit by giving a quick glance to the bar approaching the dot. Furthermore, the number indicating the speed limit may be displayed at the speedometer as shown by ‘120’ in a circle at a right-upper side of the circular-shaped scale in FIG. 3 and FIG. 4. Also, the current speed may be indicated by numbers, too, in the middle portion of the circular-shaped scale as shown in FIG. 3 and FIG. 4.

In the present way, the speedometer display step S300 may light and display the dots and numbers in the speed limit area according to the speed limit information determined in the speed limit comparison step S200 to improve the driver's cognitive convenience, and may rapidly determine whether the speed of the vehicle exceeds or how fast or close it approaches the speed limit by helping the driver to simply look at the speedometer without their gaze movement to contribute to safe driving.

The present disclosure described above may be embodied as computer-readable code on a medium in which a program is recorded. The computer-readable medium includes all types of recording devices in which data readable by a computer system is stored. Examples of the computer-readable medium include a Hard Disk Drive (HDD), a solid-state drive (SSD), a silicon disk drive (SDD), a read-only memory (ROM), a random-access memory (RAM), a CD-ROM, a magnetic tape, a floppy disk, an optical data storage device, and the like.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A displaying apparatus for a vehicle, the displaying apparatus comprising:
a speed limit recognition unit configured to obtain a speed limit of a road on which the vehicle travels; and
a speedometer display unit configured to display a visual bar varying according to a current speed of the vehicle on a background speed scale image and display a visual indicator for the speed limit at a corresponding position of the background speed scale image.

2. The displaying apparatus of claim 1, wherein the speed limit recognition unit is further configured to recognize an image of a road sign based on an image of a pre-registered speed limit sign and obtain the speed limit based on numbers in the image of the road sign.

3. The displaying apparatus of claim 1, further including a speed limit comparison unit configured to compare the speed limit with a previous speed limit displayed on the speedometer display unit, and determine to change the previous speed limit.

4. The displaying apparatus of claim 1, wherein the speedometer display unit is configured to adjust a length of the visual bar according to the current speed of the vehicle so that the visual bar approaches the visual indicator as the current speed approaches the speed limit.

5. The displaying apparatus of claim 4, wherein the visual indicator includes a dot.

6. The displaying apparatus of claim 4, wherein the visual bar includes a round bar.

7. The displaying apparatus of claim 1, further including a speed limit comparison unit configured to compare the speed limit obtained by the speed limit recognition unit with a previous speed limit previously displayed on the speedometer display unit to determine which to display.

8. The displaying apparatus of claim 1, wherein the background speed scale image includes a circular scale, and the speedometer display unit is further configured to display the speed limit inside the circular scale.

9. The displaying apparatus of claim 2, further including a camera configured to obtain the image of the road sign.

10. A displaying method for a vehicle, the method including:
a speed limit recognition step of obtaining, by a controller provided in the vehicle, a speed limit of a road on which the vehicle travels; and
a speedometer display step of displaying, by the controller, a visual bar varying according to a current speed of the vehicle on a background speed scale image and displaying a visual indicator for the speed limit at a corresponding position of the background speed scale image.

11. The method of claim 10, wherein the speed limit recognition step includes recognizing an image of a road sign based on an image of a pre-registered speed limit sign and obtaining the speed limit based on numbers in the image of the road sign.

12. The method of claim 10, further including comparing the speed limit with a previous speed limit displayed on a speedometer display unit, and determining to change the previous speed limit.

13. The method of claim 10, wherein the speedometer display unit is configured to adjust a length of the visual bar according to the current speed of the vehicle so that the visual bar approaches the visual indicator as the current speed approaches the speed limit.

14. The method of claim 13, wherein the visual indicator includes a dot.

15. The method of 13, wherein the visual bar includes a round bar.

16. The method of 10, further including a speed limit comparison step of comparing the speed limit obtained by a speed limit recognition unit with a previous speed limit previously displayed on a speedometer display unit to determine which to display

17. The method of 10, wherein the background speed scale image includes a circular scale, and a speedometer display unit is further configured to display the speed limit inside the circular scale.

18. The method of 10, further including a step of obtaining the image of the road sign by use of a camera.

19. A non-transitory computer-readable storage medium storing computer-readable instructions to cause one or more processors to perform the displaying method of claim 1.
